(19) United States
(12) Patent Application Publication
(10) Pub. No.: US 2017/0073094 A1
(43) Pub. Date: Mar. 16, 2017

(54) Encapsulating Method and Device for Hollow Roller Cover

(71) Applicant: Daniel Ellis Hall, Manchester, NH (US)

(72) Inventor: Daniel Ellis Hall, Manchester, NH (US)

(21) Appl. No.: 14/855,178

(22) Filed: Sep. 15, 2015

(51) Int. Cl. B65B 25/24; B65B 7/06; B29C 65/00

(52) U.S. Cl. CPC B65B 25/24; B29C 65/002; B65B 7/06; B29L 2031/712

(57) ABSTRACT

This relates to an encapsulating method and a cylindrical sleeve device for storing a hollow roller cover particularly when the material of the cover is covered with material in an unset condition. This encapsulating method comprises using the hollow interior cylindrical portion of a hollow roller cover, an oversized plastic bag, inserting the excess plastic bag into one end of the hollow roller cover, then inserting the inner reduced diameter cylindrical sleeve devise which encloses the hollow roller cover by wedging the excess of plastic of the oversized plastic bag between the inner hollow roller cover and the outer sides of the cylindrical sleeve devise, hermetically sealing the hollow roller cover creating an air tight enclosure to form an unconventional cylindrical container allowing for temporarily storing and re-use of the roller cover.

### BACKGROUND OF THE INVENTION

Field of Use

Rollers come in a variety of shapes, sizes, diameters and lengths and are used for a variety of applications, such as, for example, painting or for applying glue for flooring or sheet goods. Typically, the rollers include a nap that can be impregnated and/or coated with a coating material (e.g., paint, shellac, glue or the like) and then used to coat a surface with the material.

The cleaning of a wet or soiled roller cover after the applying process is a highly undesirable, sometimes impossible with glue(s) and some darker paint colors such as red or yellow, is a very time consuming process and is often ignored by the user leading to the destruction of the paint roller cover as the wet material, sets and are usually thrown away and replaced by new ones for the following day's work.

In many cases the same paint roller cover is intended to be used for the same paint material after a period of time for example while a first coat of a paint material sets or is stored for future touchups of the same color paints. In many glue type applications the roller cover could be stored for the next several projects and thus saving resources.

Paint rollers have three major components: core, adhesive, and fabric. The core is the base of the paint roller. The core can be constructed from a wide range of materials known to one skilled in the art (e.g. plastic, cardboard, and phenolic-impregnated materials). An adhesive is applied to the outside of the core and is utilized to attach the fabric. Typically, the adhesive is epoxy based. Other adhesives known to one skilled in the art are also utilized. The fabric of the roller typically comprises fibers woven or knitted to a backing and adhesively applied to the roller core. Fabrics include natural fibers (e.g. wool, mohair, and lambskin) as well as synthetic fibers (e.g. nylon, polyester, acrylic, rayon, and blends of one or more synthetic fibers).

The present invention provides a simple, inexpensive, and compact means of storing a wet-filled roller, whereby the material will remain fresh and uncured. Prior attempts have been made to achieve this objective.

Background Art

U.S. Pat. No. 20140249006 (Gallardo) describes a paint roller end cap for use with paint roller covers to keep a minimum spacing between the end of the paint roller cover and an adjacent surface to a painting surface. The end cap is configured for removable attachment to an exposed end of the paint roller cover. The end cap is either an annular ring for snug fit attachment to an end plug in the roller cover or a flat disk and stem for snug fit insertion into a central tube on the roller cover. The end cap includes one of a plurality of rib, a plurality of grooves, or a protruding disk to provide the minimum spacing from the adjacent surface.

U.S. Pat. No. 20120043240 (Dvorak) discusses a receptacle with a wide open canister on top with cap that opens to receive a wet paint roller cover and roller handle assembly detailed on column 2 at line 23.

U.S. Pat. No. 20110005952 (Fenn) discusses a storage container for a roller cover and roller frame as described on column 2 line 60.

U.S. Pat. No. 20090205980 (Hart; Gregory R. et al.) claims a method using a containing structure, inserting the applicator, and pressing the container against a wall at column 1, 2 line 98

U.S. Pat. No. 20060054527 (Hart; Gregory R. et al.) column 2 line 18 states a containing structure which when closed is substantially sealed, column 1 line 22 describes an assembly structure, column 1 line 30 discusses a method by which the structure is sealed by pressing the containing structure against a wall or using adhesive strip to close a flap of plastic, column 1 line 79 describes closing off the interior chamber of the containing structure by using adhesive tape between the interface of the front wall, a threaded string closure system, a zipper-type closure system such as the Ziploc™, a hook and loop fastener system such as the Velcro™, or other closure systems such as a button or snap-in place like mechanical system.

U.S. Pat. No. 20030188980 (Myers) involves a molded plastic housing with a plastic hinge that opens to receive a wet paint roller cover and roller handle assembly column 1 line 23.

U.S. Pat. No. 6,530,470 (Roundy) discloses a convenient box preferably made of plastic that enables effective storage of a paint applying roller while the roller is wet with paint, the storage of the roller kept on a temporary basis.

U.S. Pat. No. 5,966,902 (Korycki) discloses a paint roller cover container as discussed in column 1 at line 43, constructed with an upper and lower cover section joined along a common joint with a hinge and formed with a corresponding depression so that when the halves are closed on one another they define an elongated chamber of a size and shape to accommodate a paint roller. Further, the sections are molded as one piece of plastic material joined across a living hinge and are preformed to shape to accommodate a roller.

U.S. Pat. No. 5,966,772 (Woodnorth) discloses a paint roller and tray system as discussed in column 2 at line 11, the tray including a floor, a plurality of upstanding walls extending from the floor to form a basin and a partitioning wall configured for being removable positioned within the base and to create a first and second pans. The tray also has a first and second roller cover as discussed further in column 2 at line 21 which are axially spaced from one another so as to allow the rollers to independently rotate within the first and second pans.

U.S. Pat. No. 5,960,946 (Gramlich) discloses a modified paint roller tray having sides, a back wall, a front wall, and a two-part bottom. Further in column 2 at line 1, pair of pivot points are attached to the back wall in order to secure the lid to the tray. Further down in column 2 at line 47, the lid can be made from the same type of material as the tray however it could be made from a different material for example the tray could be made from metal and the lid made from plastic.

U.S. Pat. No. 5,915,552 (Kim) discloses a paint roller protective device with an elongated shell including an end wall, sidewalls, an open end for receiving the roller, and a closed end, as well as a cap to seal off the open end.

U.S. Pat. No. 5,887,708 (Gonzales) discloses a paint tray cover as discussed in column 3 at line 56, including a bag for receiving the paint tray, the bag having an open end and fabricated of plastic material. The bag is chemically resistant to withstand prolonged contact with latex or oil-based paints. The bag also has upper surface and a lower surface and a hollow interior. The lower surface has a pair of holes in a spaced relationship dimensioned to receive the paint tray feet. The open end of the bag is pinched together so that the second and third pair of holes are in alignment under the front edge of the paint tray. Further in column 3 at line 18, the bag is positioned over the paint tray and user then fills the tray with paint as usual. Paint causes the plastic of the bag to conform to the bottom of the tray. Further at line 27, the bags can also be used to wrap up the roller covers and brushes and keep them from drying out overnight.

U.S. Pat. No. 5,709,301 (Couch) discloses a storage device for paint rollers, paint roller covers, and paint brushes. The storage device is a cylindrical container having a lid, which is flared out at the upper portions and has a foam insert at the bottom for forming a spongy seal with the paint implement. The container has a core around which the roller cover fits. The lid can be either a screwdown or friction fit lid, and has a foam insert on its underside to form a spongy seal with the upper part of the roller cover.

U.S. Pat. No. 5,553,701 (Jarecki) discloses a paint tray assembly consisting of a paint tray and a separate cover which is attached to and removed from the tray by meeting peripheral ribs on the underside of a lid and the top tray edge. This paint tray and lid combination are composed of rigid plastic materials or the like.

U.S. Pat. No. 5,533,617 (Von Flatern) discloses a storage container for a paint roller sleeve and has a flexible resilient tubular housing for removably storing the sleeve.

U.S. Pat. No. 5,440,853 (Engdahl) discloses a rigid plastic cylindrical tube as referred to in column 1 at line 50, whose open distal end is closed and sealed by a plastic distal end cap.

U.S. Pat. No. 5,316,137 (Kyllonen) discloses a rigid paint roller tray and lid having a seal for a resealable airtight mating of the tray with the lid.

U.S. Pat. No. 5,178,274 (Long) discloses a rigid paint roller holder container with two parts, the container and a snap on lid. The container has four molded elements including a recessed support for the paint roller handle, two post supports for supporting shorter paint rollers, a support for longer paint rollers, and grooves for the snap on lid.

U.S. Pat. No. 5,174,445 (Mull) discloses a paintbrush storage bag assembly for storing a paintbrush in a storage liquid between uses and also holding the brush while in use. As discussed in column 3 at line 7, the brush is positioned in a heavy foil bag which is pleated and tapered to provide a relatively large base. The liquid in the bag provides ballast to prevent tipping. The foil from the bag is similar to that in which vacuum packed coffee is sold. Further at line 20, the pleats of the bag are secured together by complementary look and loop fastener members. The bristles of the brush are sealed in the bag by a large wide elastic band such as a rubber band. The band is secured onto the brush around the ferrule or top portion of the bristles, in a tensioned condition. The band rolls down and tightly seals the sides of the bag and prevents spillage during operation.

U.S. Pat. No. 5,138,738 (Nicholson) discloses a coating applicator having a bag detachably mounted on a paint brush head and covers the entire fiber portion of the paint brush. The bag is close fitting and conforms to the outline of the paint brush fibers. A drawstring, Velcro fasteners, or elastic bands allow the bag to be mounted to the paint brush head. The bag as discussed in column 5 at line 33, has a rolled edge or partly rolled with an angular ring of absorbent material covered by the rolled edge. The material for the bag can be a woven, knit or felt cloth and may be fine, course, thick or thin. The coating applicator is applicable for painting, but also renders paint brushes suitable for applying stains, varnishes and the like.

U.S. Pat. No. 5,074,098 (Filipchuk) discloses a container for storing a wet paint roller comprised of a cylindrical sleeve with two end caps.

U.S. Pat. No. 5,032,188 (Kettle et al.) discloses a sealed sachet constructed of a material substantially impermeable to air and water into which the brush head can be inserted immediately after use without any prior cleaning, the sachet containing a small quantity of brush preservative or cleaning liquid to prevent any paint remaining on the bristles from drying or hardening. The sachet is sealable around the brush handle, or is provided with means for sealing the open mouth of the sachet around the handle to restrict air into the sachet. In column 5 at line 18, the sealed sachet comprises two multiple lamina, paper laminar layer and a plastic foil laminar layer, such as is commercially available for variety of different purposes in the packaging art. The layers are heat sealed one to the other around the periphery to form a sealed sachet containing a small quantity preservative liquid. At line 25 the inner surfaces of the sachet are metal foil, the outer layers are paper or plastics and suitable for printed advertising matter or instructions or both.

U.S. Pat. No. 4,967,903 (Kettle et al.) discloses essentially the same subject matter as the kettle '188 patent, with variations in the claims.

U.S. Pat. No. 4,802,576 (Kern) discloses a waffle iron looking device or storage container for a paint roller including a housing with a recess for the paint roller and a roll of foil to provide a form of hermetic sealing.

U.S. Pat. No. 4,765,123 (Caldwell) discloses a process for covering a paint tray so that it may be reused without the necessity of cleaning As discussed in column 2 at line 9, the flexible paint impervious bag has an opening with a girth sufficiently large fit over the floor end of the paint tray. The girth is sufficiently large so that the bag in addition to fitting over the floor end is also large enough so that it lies down into the floor of the tray against the inner surface of the sides. Paint can be held within the tray and along the outer surface of the bag, allowing the tray to be used in a conventional manner but avoiding the necessity of cleaning the tray.

U.S. Pat. No. 4,738,358 (Kehl) discloses a paint roller cover container and extractor assembly simplifying the cleanup process. As discussed in column 2 at line 25, the container is preferably made of a polymeric plastic, and is generally cylindrical and shaped as a hollow tube having a closed bottom and an open top.

U.S. Pat. No. 4,541,542 (Florentino) discloses a paint tray cover as discussed in column 2 at line 23, containing a surface with a spatial protrusion to accommodate a paint roller brush handle. The cover is made of a flexible semi rigid material, such as polyethylene which will allow a snug airtight fit over a conventional paint tray. The spatial protrusion is performed as a wedged shaped cavity.

U.S. Pat. No. 4,334,416 (Turano) presents an apparatus for soaking and preserving paint roller cover sleeves having an open top receptacle with bottom and side walls for holding a quantity of solvents, and a removable cap for sealing the open top portion of the container together with a post having an enlarged foot at the bottom for engaging the inside bottom of the receptacle to support the post in an upright position.

U.S. Pat. No. 3,757,990 (Buth) discloses a flexible liner for protecting a paint tray and a mechanical means for removing the flexible liner to the tray. The clips for clamping the liner to the walls of the tray act as the mechanical means, or a resilient band/drawstring or adhesive can be used to fix the liner to the tray.

U.S. Pat. No. 3,167,178 (Saunders) discloses a paint brush wrapper whereas discussed in column 1 line 45 an envelope has two sides and is preferably made of plastic material. The envelope is of substantially rectangular configuration and has four edges. Each of the four edges are joined along the other to form the envelope. The first opening is formed in the envelope along one of the edges and is substantially long enough to admit the bristles of the brush and the handle in the longitudinal direction of the handle. The flap as discussed on column 2 line 11 is formed with the envelope, extends from the side, along the edge and is adapted to fold and close the opening. A snap is provided to secure the flap to the side of the envelope.

### SUMMARY OF THE INVENTION

This invention relates to an encapsulating method and device for storing a hollow roller cover particularly when the cover is wet with material in an unset condition. Unlike any prior art, this encapsulating method comprises using the hollow interior cylindrical portion of a roller cover, an oversized plastic bag, inserting the excess plastic bag into one end of the roller cover then inserting a cylindrical sleeve devise which wedges the plastic between the inner hollow roller cover and the outer cylindrical end of the sleeve devise, thereby hermetically sealing the wet roller cover creating an air tight capsule or enclosure to form an unconventional cylindrical enclosure.

The purpose of the invention is to eliminate the need for bulky, expensive, ineffective and time consuming methods of maintaining a wet hollow roller cover for use at another time. The invention thus saves time, money and supplies for the consumer.

One object of the present invention is to provide a means to store a used hollow roller cover between sessions without the need to clean the roller.

Another object of the present invention is to store a wet hollow roller cover for future use.

Another object of the present invention is to keep the wet material on the hollow roller cover from drying during a period of non-use.

Another object of the present invention is to be inexpensive and manufactured easily.

Another object of the present invention is to be simple to use and store.

Other objects will be apparent from the following Descriptions and Drawings.

### BRIEF SUMMARY OF DRAWINGS

The accompanying drawings, which are incorporated in and constitute a part of the specification, illustrate preferred embodiments of the inventions. These drawings, together with the general description of the invention given above and the detailed description of the preferred embodiments given below, serve to explain the principles of the method and device inventions.

FIG. 1 is a longitudinal view of a hollow roller cover;

FIG. 2 is a longitudinal view of a hollow roller cover inside an oversized plastic bag and showing the oversized plastic bag opening;

FIG. 3 is a cross sectional view of a the excess plastic of the oversized bag after it has been pushed into the hollow roller cover;

FIG. 4 is a cross sectional view of a hollow roller cover, the oversized bag and the cylindrical sleeve devise when the method when completed;

FIG. 5 is an end view in the direction of arrow A in FIG. 3; depicting the air-tight seal when encapsulating method after completed;

FIG. 6 is a surface view of the encapsulating method when complete; and

FIG. 7 is a longitudinal view of the cylindrical sleeve devise.

### DETAILED DESCRIPTION OF THE INVENTION

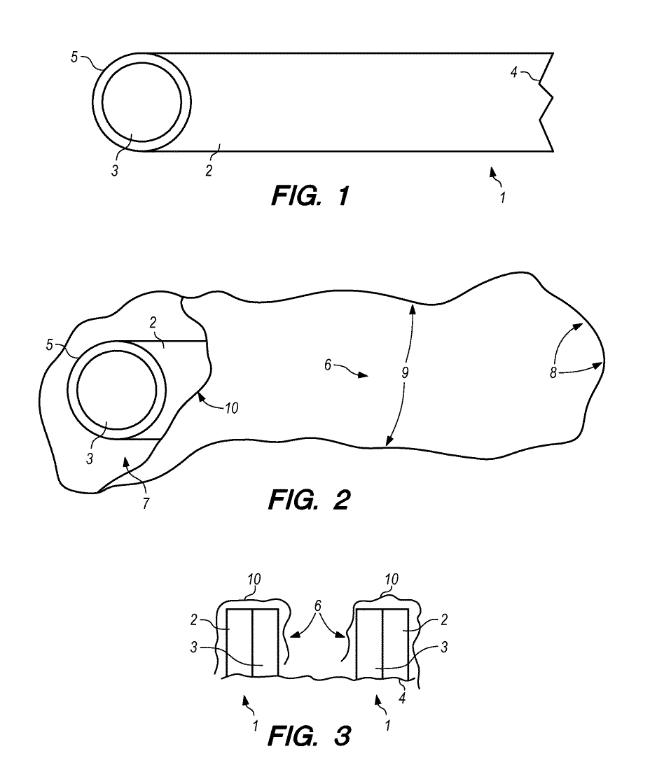

Referring first to FIG. 1, a hollow roller cover is generally designated by reference numeral 1 and a nap material is shown at 2. The hollow roller cover 1 is essentially of conventional construction and comprises a rigid hollow cylindrical longitudinal core which is indicated at 3, and a nap 2 made of a material suitable for applying wet materials. Typically, rigid hollow cylindrical longitudinal core 3, shown here at its distal end, will be a plastic tube and the nap material 2 will be fuzzy like. Since roller covers come in different lengths, it is identified with numeral. The distal side of the hollow roller cover 1 is referenced with numeral 5.

Referring next to FIG. 2, which depicts the hollow roller cover in FIG. 1 at 1, placed into an oversized plastic bag 6, and showing the distal end 5 of the hollow roller cover at the opened side 7 of the oversized plastic bag 6. Also note that opposite the open side 7 of oversized plastic bag 6, as the hollow roller cover at the proximal end is covered by the oversized plastic bag's proximal end depicted as 8. Plastic bags are typically made of a polyethylene type plastic and are typically four sided consisting of two closed elongated sides 9, one proximal side 8 which is also a closed side, and the distal side 10 which is open and is indicated with numeral 10. The cylindrical core is indicated at 3, and the nap material 2, is also shown to be inside the oversized plastic bag 6.

FIG. 3 is a cross sectional view indicating the oversized plastic bag 6, at its distal end 10, after it has been pushed or folded into the distal end of cylindrical core 3, and the plastic of the oversized bag 6 has covered, the hollow roller cover 1, which includes the nap material 2 and the cylindrical core 3. And because roller covers and cylindrical sleeve devise may come in different lengths, it is identified with numeral 4.

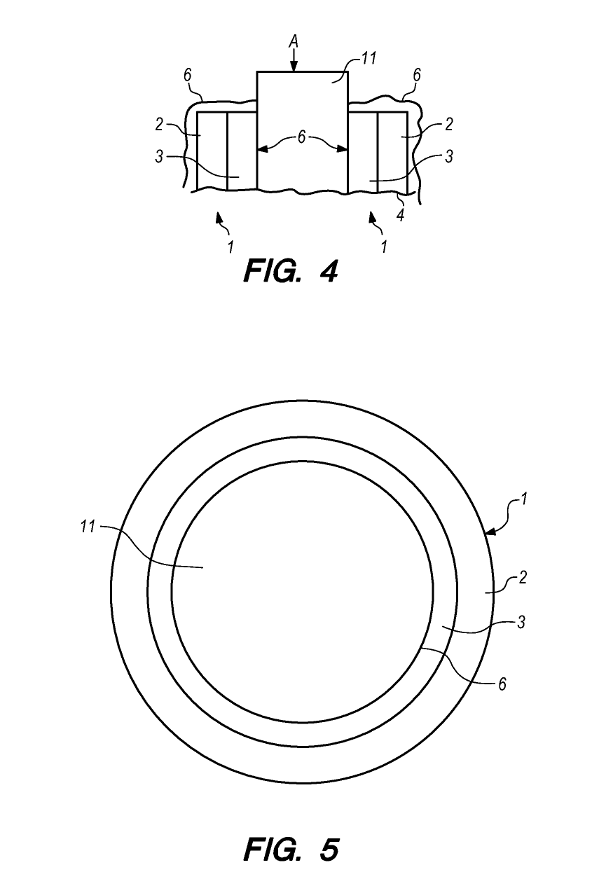

Referring to FIG. 4, which depicts a cross sectional view of a hollow roller cover 1 which includes the nap 2 and the cylindrical core 3, when the encapsulating method described herein is completed. The encapsulating method combines the hollow roller cover 1, the oversized plastic bag 6, then pushing the excess distal end 10 of the oversized plastic bag 6 into the exposed cylindrical core 2, and completing the encapsulating method by inserting the cylindrical sleeve devise 11, with its proximal or distal end having an outer end diameter that is less than the inner diameter as compared to the inner diameter cylindrical hollow roller cover 1 at its proximal and distal ends which then creates the air-tight seal and completes the encapsulating method described herein.

FIG. 5 is an end view in the direction of arrow A in FIG. 3; the hollow roller cover 1, which includes the nap material 2 and the cylindrical core 3, the distal end 10 of the oversized plastic bag 6, and the inserted cylindrical sleeve devise 11. The illustration depicts the oversized plastic bag 6 sandwiched between the cylindrical core 3 and the cylindrical sleeve devise 11. FIG. 5 also shows the encapsulating method in its completed stage with either the proximal or distal end of the cylindrical sleeve devise 11 having an outer end diameter that is less than the inner diameter as compared to the inner diameter cylindrical hollow roller cover at its proximal and distal ends 5, is inserted or press fit, also depicted in FIG. 4, which then creates the air-tight seal and completes the encapsulating method described herein.

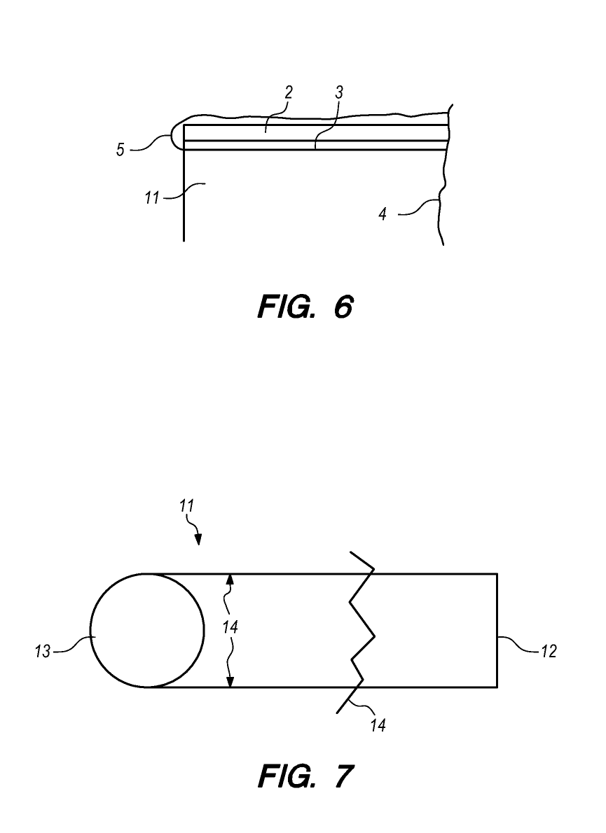

FIG. 6 is longitudinal surface view of the encapsulating method when complete; note that the nap material 2 and the cylindrical core 3 are encapsulated by the oversized plastic bag 6, as the cylindrical sleeve devise 11 is wedged against the cylindrical core 3, completing the airtight seal. And because roller covers come in different lengths, it is identified with numeral 4.

FIG. 7 is a is a longitudinal view of a tubular cylindrical sleeve devise 11 having opened or closed proximal 12 and distal ends 13, and a constant cross section along its entire length from proximal end 12 to distal end 13, with at least one end having an outer end diameter 14 that is less than the inner diameter as compared to the inner diameter cylindrical hollow roller cover 1 cylindrical core 3 at its proximal and distal ends 5, and being dimensioned to conform closely to industry standard hollow roller covers 1. FIG. 7 also depicts a cylindrical sleeve devise 11 constructed of polyethylene plastic, metals, resins or wood materials, having and elongated shape 11 and varying in length shown as numeral 14. FIG. 7 also depicts a cylindrical sleeve devise 11 that is hollow, solidly filled or partially filled.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention.

While the invention has been explained by a detailed description of certain specific embodiments, it is understood that various steps in the method, modifications and substitutions can be made in any of them within the scope of the appended claims which are intended also to include equivalents of such embodiments. For example, equivalent elements may be substituted for those illustrated and described herein and certain features of the invention may be utilized independently of the use of other features, all as would be apparent to one skilled in the art after having the benefit of this description of the invention. Further modifications and alternative embodiments of this invention will be apparent to those skilled in the art in view of this specification.

I claim:

1. An encapsulating method comprising:
a.) a hollow roller cover having identical proximal and distal ends;
b.) covering the hollow roller cover including the proximal end with an oversized plastic bag;
c.) inserting the excess plastic bag into the inner distal end of the roller cover; and then
d.) inserting and press fitting a cylindrical sleeve devise into the distal end of the inner hollow roller cover; which
e.) encapsulates the hollow roller cover by wedging the plastic between the inner hollow roller cover and the outer cylindrical sleeve devise, thereby hermetically sealing the hallow roller cover creating an air tight enclosure to form an unconventional cylindrical container allowing for temporarily storing and re-use of a hollow roller cover.

2. An encapsulating method in accordance with claim 1, further comprising: a hollow roller cover having identical interior proximal and distal ends, with an outer nap material and an inner rigid core.

3. An encapsulating method in accordance with claim 1, further comprising of a standard 4 sided plastic bag closed at 3 sides, with and opening on one side and generally made with a polyethylene type plastic.

4. An encapsulating method in accordance with claim 1, wherein the oversized plastic bag is placed over the hollow roller cover or by placing the hollow roller cover inside the oversized plastic bag, covering the hollow roller cover, including the proximal end.

5. An encapsulating method in accordance with claim 1, wherein the upper, open portion of the oversized plastic bag is taller than the hollow roller cover at the distal end.

6. An encapsulating method in accordance with claim 1, wherein the excess of the oversized plastic bag is pushed and/or folded into the interior cylindrical core portion of the distal end of the hollow roller cover.

7. An encapsulating method in accordance with claim 1, wherein a cylindrical sleeve devise is inserted into the interior cylindrical core portion of the distal end of the hollow roller cover.

8. An encapsulating method in accordance with claim 1, wherein the sealing method comprises of inserting and press fitting the reduced diameter cylindrical sleeve devise into the interior cylindrical portion of the distal end of the hollow roller cover after the oversized bag is pushed into the hollow interior cylindrical portion of the distal end of the roller cover, forming a hermetic seal around the entire hollow roller cover when the reduced diameter cylindrical sleeve devise is inserted or press fit.

9. An encapsulating method in accordance with claim 1, wherein a hollow roller cover is sealed air-tight when the three airtight sealing components, said interior cylindrical core portion of the distal end of the hollow roller cover, oversized plastic bag and cylindrical sleeve devise are combined, forming a hermetic and air-tight seal between the three airtight sealing components.

10. An encapsulating method in accordance with claim 1, wherein: the encapsulating method surrounds the hollow roller cover on all sides with the oversized plastic bag and when the inventive cylindrical sleeve devise is inserted, it hermetically seals the hollow roller cover, encapsulates and forms an enclosure for temporarily storing and maintaining a wet hollow roller cover in a useful condition for a limited period of time up to several months.

11. A cylindrical sleeve devise, comprising: a tubular cylindrical sleeve having opened or closed proximal and distal ends, and a constant cross section along its entire length from proximal end to distal end, with at least one end having an outer end diameter that is less than the inner diameter as compared to the inner diameter cylindrical hollow roller cover at its proximal and distal ends, and being dimensioned to conform closely to industry standard hollow roller covers.

12. The cylindrical sleeve devise of claim 11, wherein said tubular cylindrical sleeve devise is of at least one piece, having opened or closed ends, and constructed of rubber, plastic, resins, metals or wood materials or any combination thereof.

13. The cylindrical sleeve devise of claim 11, having proximal and distal ends, with at least one outer end diameter that is less than the inner diameter of a hollow roller cover at its proximal and distal ends,

14. The cylindrical sleeve device of claim 11, having an elongated shape and varying in length.

15. The cylindrical sleeve devise of claim 11, is hollow, solidly filled or partially filled.
